(19) United States
(12) Patent Application Publication
(10) Pub. No.: US 2011/0308255 A1
(43) Pub. Date: Dec. 22, 2011

(54) Combined cycle power plant

(76) Inventors: Jens Keyser, Furth (DE); Oliver Reimuth, Erlangen (DE); Ulrich Schiffers, Eckental (DE)

(21) Appl. No.: 13/159,486

(22) Filed: Jun. 14, 2011

(30) Foreign Application Priority Data
Jun. 16, 2010 (EP) 10166084.3

(51) Int. Cl. F02C 1/00; F02C 6/00

(52) U.S. Cl. 60/772; 60/39.181

(57) ABSTRACT

A combined cycle power plant with integrated coal gasification is provided. The power plant includes a gas turbine, a fuel system connected upstream of a combustion chamber of the gas turbine, which includes a gasification device for fossil fuel and a gas line branching off from the gasification device and opening out into the combustion chamber of the gas turbine, whereby a saturator for saturating the fuel with steam is connected into the gas line upstream of the combustion chamber, whereby a flushing line is provided which opens into the gas line between the gasification device and saturator.

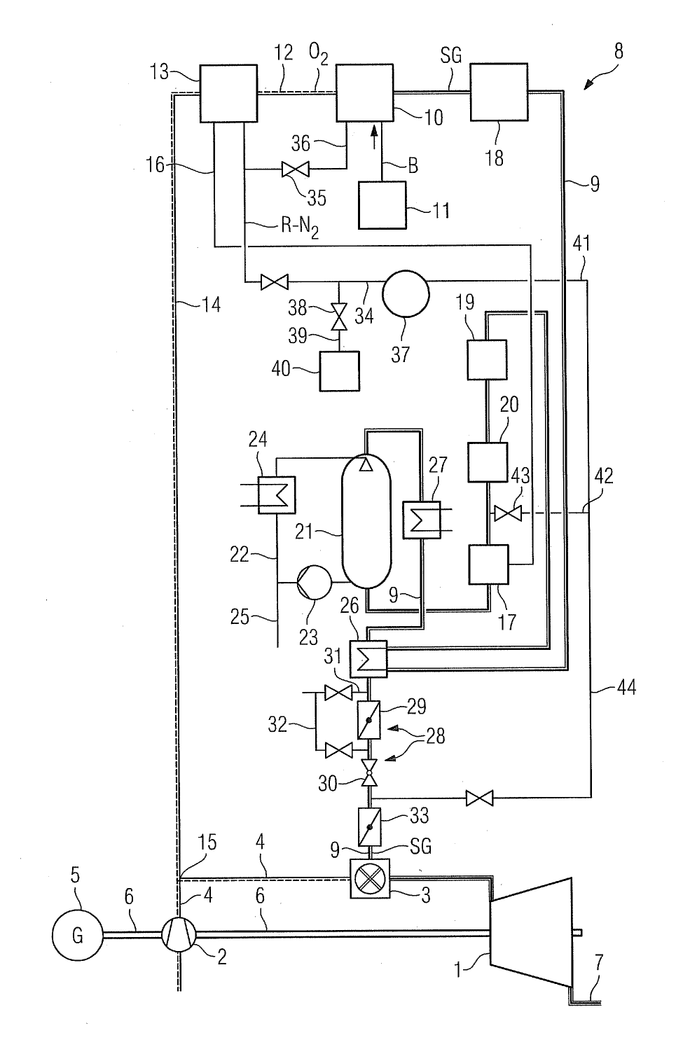

### CROSS REFERENCE TO RELATED APPLICATIONS

This application claims priority of European Patent Office application. No. 10166084.3 EP filed Jun. 16, 2010, which is incorporated by reference herein in its entirety.

### FIELD OF INVENTION

The invention relates to a combined cycle power plant with a gasification device for fossil fuel and a corresponding synthetic gas fuel system, as well as to a method for flushing out the synthetic gas fuel system of such a plant.

### BACKGROUND OF INVENTION

The task of the synthetic gas fuel system is to prepare a syngas obtained from a gasification of a fuel (e.g. coal) and subsequently cleaned for combustion in a gas turbine (in accordance with the gas turbine requirements). To enable the system to be put into operation in an orderly manner and to enable repairs to be carried out after failures/faults, there is the need to render the system inert.

In known IGCC plants (IGCC=integrated gasification combined cycle) the inerting is undertaken with the aid of steam as a flushing medium. With longer downtimes however so called shutdown corrosion can result, caused by the condensing steam within the pipes of the fuel system in conjunction with sulfur compounds (in the ppm range), which could not be separated from the syngas stream within the desulfurization plant.

To avoid this problem a flushing system with nitrogen (N₂), especially pure nitrogen, as the inerting medium was thus provided upstream of the gas turbine, with which flushing was carried out from the gas lock forwards into the gas turbine. The gas lock comprises two valves, for example ball cocks. Connected between these valves is an intermediate relief or a pressure line. The intermediate relief can be connected to a flare via which the superfluous gas can be flared off. As an alternative to the intermediate relief, a pressure line can be connected, which ensures that no gas can flow in via the gas lock valves. The gas lock, in order to satisfy the relevant security requirements, thus divides the fuel system in a gas-tight manner into a first area (gasification system) upstream of the gas lock and into a second area (gas turbine fuel system) downstream of the gas lock.

By contrast with steam, which can lead to corrosion in combination with sulfur and condensation, there is no danger of corrosion with nitrogen. The nitrogen occurs in the air separation system as highly-pure nitrogen and can thus be used for inerting the fuel system. This concept has already been patented (patent DE 10002084 C2).

The forward area of the fuel system (i.e. upstream of the gas lock and the saturator system) is not inerted in this case. If this area is also to be inerted, during normal rundown and shutdown the system is inerted from the gasifier with highly pure nitrogen and the area is held under pressure. This type of inerting is not possible however in the event of a failure of the gasifier system.

### SUMMARY OF INVENTION

The object of the invention is thus to specify a combined cycle power plant of the type mentioned above in which the fuel system can be flushed out in an especially reliable manner. In addition a method is to be specified which allows flushing of the fuel system of the combined cycle power plant in an especially simple manner.

Inventively this object is achieved by the facility in accordance with the claims and the method in accordance with the claims. Advantageous developments of the invention are defined in the respective dependent claims. The provision of a flushing line which opens out between gasification device and saturator into the gas line for a combined cycle power plant with integrated coal gasification, comprising a gas turbine, a fuel system connected upstream of a combustion chamber of the gas turbine comprising a gasification device for fossil fuel and a gas line branching off from the gasification device and opening out into the combustion chamber of the gas turbine, with a saturator for saturating the fuel with steam in the gas line being connected upstream of the combustion chamber, allows the following to be achieved:

On failure of the inerting with nitrogen via the gasifier an “emergency flushing” of the fuel system arranged downstream can be activated and executed for a specific time. This enables an inerting of the fuel system to be achieved even above the gas lock.

The advantage of this concept lies in the fact that an inerting of the part of the fuel system lying upstream can be ensured even on failure of the inerting from the gasifier side. In this way an inerting of the fuel system independent of gasifier or upstream systems is achieved. This advantage can be brought to bear in so-called poly-generation plants. Here, as well as possible electricity production by the gas turbine, additional materials (e.g. SNG=Synthetic Natural Gas or Substitute Natural Gas) are produced. If there is a fault in the downstream part of the fuel system, it is possible to continue to operate the poly-generation system, i.e. gasifier and gas treatment are still in operation. In this case the only part taken out of operation is the part of the fuel system in which the fuel is usually conditioned, i.e. systems lying downstream. Without the described concept it would not be possible to inert this part of the fuel system for maintenance purposes or the like, since gasifier and gas treatment are still in operation. This system also represents an advantage with possible start-up processes. Starting up the gasifier of an IGCC power plant can take a number of hours. Conversely it can be that for shorter maintenance work on systems lying downstream the gasifier does not have to be switched off. For this case too an independent inerting in parts of the fuel system is advantageous.

In an advantageous manner the flushing line between gasification device and a mixing facility which is connected upstream of the saturator for supplying nitrogen to the synthetic gas in the gas line, opens out into the gas line.

It is further advantageous for a desulfurization plant to be connected upstream of the point in the gas line at which the flushing line opens into the gas line.

This choice of inlet between the desulfurization plant and the mixing facility means that flushing is achieved for all components involved in fuel conditioning without having to interrupt the process of fuel cleaning.

Expediently the flushing line is connected to a pure nitrogen output of an air separation system (LZA) which delivers the nitrogen for the gasification, in which case nitrogen also occurs. The connection between the flushing line and the pure nitrogen output of the air separation system can be made directly or via further lines, for example via a feed line for nitrogen coming from the air separation system and, if further flushing lines are also provided in addition to the flushing line, via a main flushing line from which the flushing line and the further flushing lines branch off.

Advantageously a nitrogen reservoir is connected between the feed line and the main flushing line. The intermediate storage guarantees flushing for the inert medium even in the event of failure of the preparation system, i.e. the air separation system.

It is also advantageous for a reserve line, which is connected on its input side to an emergency filling system for nitrogen, especially for pure nitrogen, to open out into the feed line. This provides an especially reliable guarantee that the fuel system will be flushed out with nitrogen, especially pure nitrogen, even in the event of a failure of the air separation system.

It is advantageous for a gas lock to be connected into the gas line between saturator and combustion chamber and for a further flushing line to join the gas line between gas lock and combustion chamber, especially immediately downstream of the gas lock. In this way reliable flushing of the fuel system between the gas lock valve and the combustion chamber is guaranteed by a further measure. If only the last part of the gas line is to be flushed out, the flushing amounts required are thus especially small, which makes the operation of the plant especially cost effective.

Expediently the further flushing line branches off from the main flushing line.

With regard to the method for flushing at least a part of the fuel system of a combined cycle power plant, the object is inventively achieved by the fuel system being flushed out by introducing a flushing medium into the gas line in the direction of the combustion chamber between gasifier and saturator.

In an advantageous manner the flushing medium is pure nitrogen. Flushing with nitrogen is cost effective because of the small volume to be flushed out. Also in this case no steam has to be removed from the combined cycle system for the flushing process, which keeps the overall efficiency of the combined cycle power plant especially high. In addition stainless steels do not need to be used since no corrosion or only slight corrosion can occur.

Expediently the pure nitrogen is taken from an air separation system which is needed in any event for the provision of oxygen for the gasification.

In an advantageous manner the flushing medium is routed between a mixing facility connected into the gas line which is used for the admixture of nitrogen to the fuel and a syngas cleaning system, so that the fuel conditioning system can be flushed out independently of the fuel cleaning system. As described above this is of particular interest with poly-generation systems, in which gasifier and gas treatment can continue to be in operation while the fuel system and the downstream systems are taken out of operation.

### BRIEF DESCRIPTION OF THE DRAWINGS

The invention will be explained by way of an example which refers to the drawing. The figure, which is schematic and not to scale, is as follows:

FIGURE part of a gas turbine system of a combined cycle power plant, with a gasification device connected upstream of the gas turbine.

### DETAILED DESCRIPTION OF INVENTION

A combined cycle power plant includes a gas turbine system in accordance with the figure and a steam turbine system (not shown). The gas turbine system includes a gas turbine 1 with coupled air compressor 2 and a combustion chamber 3 connected upstream from the gas turbine 1, which is connected to a compressed air line 4 of the compressor 2. The gas turbine 1 and the air compressor 2 and also a generator 5 are attached to a common shaft 6. For feeding working medium or flue gas expanded in the gas turbine 1 into the waste heat steam generator of the steam turbine system an exhaust gas line 7 is connected to an output of the gas turbine 1.

The gas turbine system is designed for operation with a gasified natural gas or syngas SG, that is created by the gasification of a fossil fuel B. Gasified coal or gasified oil can be typically provided as syngas. To this end the gas turbine system includes a fuel system 8, via which syngas is able to be supplied to the combustion chamber 3 of the gas turbine 1. The fuel system 8 includes a gas line 9, which connects a gasification device 10 to the combustion chamber 3 of the gas turbine 1. The gasification device 10 can be fed via an insertion system 11 with coal, natural gas or oil as a fossil fuel. The fuel system 8 also includes components which are connected between the gasification device 10 and the combustion chamber 3 of the gas turbine 1 into the gas line 9.

To provide the oxygen O₂ needed for the gasification of the fossil fuel B the gasification device 10 is connected via an oxygen line 12 upstream of an air separation system 13 belonging to the fuel system 8. The air separation system 13 is able to have air applied to it on its input side. To this end the air separation system 13 is connected on its input side to an air removal line 14 which branches off at a branch point 15 from the compressed air line 4.

Part of the nitrogen N₂ obtained in the air separation system 13 during the separation of the air flow in addition to the oxygen O₂, the so-called impure nitrogen U-N₂, is fed via a nitrogen line 16 connected to the air separation system 13 to a mixing facility 17. In the mixing facility 17 the impure nitrogen U-N₂ is mixed into the syngas SG to reduce the NO_{>=x} emissions of the gas turbine. The mixing facility 17 is embodied in this case for an especially even and cold current-free mixing of the nitrogen N₂ with the syngas SG.

The syngas SG flowing out of the gasification device 13 first flows via the gas line 9 into a syngas waste heat steam generator 18, in which the syngas SG is cooled by exchange of heat with a flow medium.

Viewed in the flow direction of the synthetic gas SG beyond the syngas waste heat steam generator 18 and before the mixing facility 17, a dust removal device 19 for the syngas SG as well as a desulfurization system 20 are connected into the gas line 9. In an alternate version, instead of the dust removal device 19, especially for gasification of oil as the fuel, a soot washing facility can also be provided.

For an especially low pollutant emission for the combustion of the gasified fuel in the combustion chamber 3 there is provision for the gasified fuel to be charged with water vapor before its entry into the combustion chamber 3. From the heating technology standpoint this can be done very advantageously in a saturator system. To this end a saturator 21 is connected into the gas line 9, in which the gasified fuel is routed against the flow of heated saturator water. The saturator water circulates in this case in a saturator circuit 22 connected to the saturator 21, into which a recirculation pump 23 and also, for preheating the saturator water, a heat exchanger 24 are connected. To compensate for the losses of saturator water occurring during the saturation of the gasified fuel, a feed line 25 is connected to the saturator circuit 22.

Viewed in the direction of flow of the synthetic gas SG beyond the saturator 21 a heat exchanger 26 acting on the secondary side as they syngas-mixed gas heat exchanger is connected into the gas line 9. The heat exchanger 26 is likewise connected in this case into the gas line 9 on the primary side at a point before the dust removal device 19, so that the syngas SG flowing into the dust removal device 19 transfers part of its heat to the syngas SG flowing out of the saturator 21. There can also be provision for routing the synthetic gas SG via the heat exchanger 26 before it enters the desulfurization plant 20 in such cases for a modified circuit concept in respect of the other components. In particular, when a flue gas washing device is connected in, the heat exchanger can preferably be arranged on the synthetic gas side downstream of the flue gas washing device.

Between the saturator 21 and the heat exchanger 26 a further heat exchanger 27 is connected into the gas line 9 on the secondary side, which on the primary side can be heated by feed water or also by steam. Through the heat exchanger 26 embodied as a synthetic gas-natural gas heat exchanger and the heat exchanger 27 guarantees in this case an especially reliable preheating of the synthetic gas SG flowing into the combustion chamber 3 of the gas turbine 1 even for different operating states of the combined cycle power plant.

When the fuel system 8 is shut down it needs to be flushed out. This is done in accordance with the prior art by a first and a second area of the fuel gasification system 8 being separately flushed out in one or more steps with nitrogen. The gasification system (first area) and the gas turbine fuel system (second area) are separated from each other in this case by a gas lock 28. The gasification system in this case includes the gasification device 10 as far as the gas lock 28 and the gas turbine fuel system includes the gas lock 28 and the downstream components as far as the combustion chamber 3 of the gas turbine 1.

The gas lock 28 is arranged after the heat exchanger 26 in the gas line 9. The gas lock 28 comprises a fast-action locking valve 29 arranged in the gas line 9 which is connected directly downstream of a gas lock valve 30 embodied as a ball cock. Via the waste gas line 31 upstream from the gas lock valve 29, residual gas for flushing after switching off the gasification device or for flushing the saturator and the downstream heat exchanger is vented to a flare. The waste gas line 31 with associated valve serves as a pressure relief system 32 of the gas lock 28. The gas line 9 is able to be sealed off in a gas-tight manner by the gas lock 28 and if necessary is able to be locked by the fast-action locking valve 29 in an especially short time.

Immediately downstream from the gas lock 28 is a control valve 33 connected into the gas line 9, by which the fuel flow to the gas turbine is regulated in all load cases.

For flushing the gasification system or the first area of the fuel system with nitrogen N₂, i.e. from the gasification device 10 up to the gas lock 28, pure nitrogen R-N₂ is provided from the air separation system 13. To this end the nitrogen N₂ generated during the separation of the airflow L in addition to the oxygen O₂ is drawn off as pure nitrogen R-N₂ via a feed line 34 from the air separation system 13. A branch line 36 able to be blocked with a valve 35 branches off from the feed line 34, which for flushing out the first area of the fuel system 8 opens out into the gasification device 10 for fossil fuel B.

The provision of pure nitrogen R-N₂ as a flushing medium for flushing the second area or the gas turbine fuel system 8 with nitrogen N₂ is likewise known. In this case the feed line 34 opens into a nitrogen store 37. A reserve line 39 able to be blocked off with a valve 38, which is connected on its input side to an emergency filling system 4 for pure nitrogen R-N₂, additionally opens out into the feed line 34. The fact that the nitrogen store 37 is connected both to the air separation system 13 and also to the emergency filling system 40, enables it to be supplied both with pure nitrogen R-N₂ from the air separation system 13 and also with pure nitrogen R-N₂ from the emergency filling system 40. In this way flushing of the gasification system 8 can be guaranteed especially reliably even in the event of a failure of the air separation system 13. The nitrogen store 37 is dimensioned in this case such that it covers the demand for pure nitrogen R-N₂ for the flushing process including sufficiently high reserve capacity. The nitrogen store 37 is connected on the output side via a main flushing line 41 and a further flushing line 44 to the gas line 9. The emergence of the further flushing line 44 into the gas line 9 occurs downstream in the flow direction of the synthetic gas SG directly after the gas lock 28, i.e. after the gas lock valve 30.

For each switchover of the gas turbine 1 from synthetic gas SG to a second fuel which corresponds to a change of the combustion gas supplied to the combustion chamber 3, there is provision for the gas turbine fuel system 8 to be flushed out with nitrogen. The synthetic gas SG present in the gas turbine fuel system must be flushed out almost completely by the flushing process for safety reasons.

To flush out the first area of the fuel system 8 or the gasification system with pure nitrogen R-N₂ pure nitrogen R-N₂ is injected by the feed line 34 and the branch line 36 into the gasification device 10. There is usually provision here for a forward flushing of the area between the gasification device 10 and the gas lock 28 with sufficiently large quantities of pure nitrogen R-N₂ as a flushing medium over a longer period of time to guarantee that the synthetic gas SG is completely forced out of this area of the fuel system 8. The waste gas of the flushing process is taken out of the combustion system 8 by the waste gas line 31 upstream of the gas lock 28.

The fuel system between the gas lock 28 and the combustion chamber 3 of the gas turbine 1 is flushed out with pure nitrogen R-N₂ in the forwards direction. To this end the pure nitrogen R-N₂ generated in the air separation system 13 is fed via the nitrogen line 41 and the further flushing line 44 to the gas line 9. Because of the small volume of this system a forward flushing with pure nitrogen R-N₂ is sufficient.

If gasifier and gas treatment are (still) in operation e.g. because the plant involves is a poly-generation plant or if the gasifier has just started up, which can take several hours, or if the gasifier is not to be switched off for short-duration maintenance on systems lying downstream of the gasifier, the option of flushing by the gasifier is not available.

Inventively an “emergency flushing” of the fuel system arranged downstream of the gasifier is activated and executed over a specific period with which an inerting of the fuel system is also achieved above the gas lock.

To this end pure nitrogen is supplied via the main flushing line 41 and the flushing line 42 able to be blocked off with the valve 43 of the gas line 9 between the mixing facility 17 and the desulfurization plant 20. Flushing with impure nitrogen via the nitrogen line 16 directly into the mixing facility 17, because the proportion of oxygen of the impure nitrogen is too high, does not fulfill the same purpose. An injection of pure nitrogen from the air separation system 10 directly into the nitrogen line 16 for impure nitrogen is not sensible since it is not cost-effective. This variant would be more time-consuming and uses up more pure nitrogen since the entire nitrogen line 16 would first have to be flushed out once itself.

1.-12. (canceled)

13. A combined cycle power plant with integrated coal gasification, comprising:
a gas turbine; and
a fuel system connected upstream of a combustion chamber of the gas turbine, comprising:
a gasification device for fossil fuel,
a gas line branching off from the gasification device and opening into the combustion chamber of the gas turbine, and
a saturator for the saturation of the fuel with steam being connected upstream of the combustion chamber into the gas line,
wherein a flushing line is provided which opens into the gas line between the gasification device and the saturator.

14. The combined cycle power plant as claimed in claim 13, wherein upstream of the saturator a mixing facility for a supply of nitrogen to the syngas is connected into the gas line whereby the flushing line opens out between gasification device and the mixing facility into the gas line.

15. The combined cycle power plant as claimed in claim 13, wherein a desulfurization plant is connected upstream of a point in the gas line at which the flushing line opens into the gas line.

16. The combined cycle power plant as claimed in claim 13, wherein the flushing line is connected via a main flushing line and a feed line to a pure nitrogen outlet of an air separation system.

17. The combined cycle power plant as claimed in claim 16, wherein an intermediate nitrogen store is connected between the feed line and the main flushing line.

18. The combined cycle power plant as claimed in claim 16, wherein a reserve line opens into the feed line, which is connected on its input side to an emergency filling system for nitrogen.

19. The combined cycle power plant as claimed in claim 18, wherein the nitrogen is pure nitrogen.

20. The combined cycle power plant as claimed in claim 16, wherein a gas lock is connected into the gas line between the saturator and the combustion chamber and a further flushing line opens into the gas line between the gas lock the and combustion chamber.

21. The combined cycle power plant as claimed in claim 20, wherein the further flushing line branches off from the main flushing line.

22. A method for flushing out a part of a fuel system of a combined cycle power plant with integrated gasification, comprising:
providing a gasifier in the fuel system from which a gas line branches off, which opens into a combustion chamber;
providing a saturator in the fuel system which is connected into the gas line; and
flushing out the fuel system by an introduction of a flushing medium into the gas line between gasifier and saturator in a direction of the combustion chamber.

23. The method as claimed in claim 22, wherein the flushing medium is pure nitrogen.

24. The method as claimed in claim 23, wherein the pure nitrogen is taken from an air separation system.

25. The method as claimed in claim 22, wherein the flushing medium is supplied between a mixing facility connected into the gas line which is used for mixing nitrogen into the fuel, and a self removal system.
